(19) United States
(12) Patent Application Publication
(10) Pub. No.: US 2012/0111140 A1
(43) Pub. Date: May 10, 2012

(54) Antirotation Device

(76) Inventors: Hans-Joachim Buechelmaier, Hohenfels (DE); Daniel Jansen, Tuttlingen (DE); Charles Chambonneau, Joue les Tours (FR); Torbjorn Hedmann, St. Cyr sur Loire (FR); Romuald Lescorail, St. Laurent en Gatines (FR)

(21) Appl. No.: 13/126,413

(22) PCT Filed: Oct. 27, 2008
(86) PCT No.: PCT/EP2008/009064

§ 371 Date: Oct. 14, 2011

(51) Int. Cl. F16H 53/06

(52) U.S. Cl. 74/569

(57) ABSTRACT

An Antirotation device for an element being moveable back and forth along an axis, particularly a periodically actuable tappet for a valve train or a pump, comprises following features: The device is substantially mushroom-shaped consisting of one trunk section and one head section, the trunk section is circular-cylindrical-like and designed to be arranged in a circular hole or cavity of said element, particularly of a hollow circular-cylindrical part of said element, and the head section is between a longitudinal cut-off of a circular-like cylinder and a cut-off of a spherical and designed to slide in a guide of a bore surrounding said element.

The invention concerns an antirotation device for an element being moveable back and forth along an axis, particularly a periodically actuable tappet for a valve train or a pump.

A tappet with a separate antirotation device is e.g. known from DE 195 01 061 A1, whereby the separate antirotation device is a needle or cylindrical roller.

It is one object of the invention to provide an improved antirotation device for an element being moveable back and forth along an axis, particularly a periodically actuable tappet for a valve train or a pump, which enables a cost-effective manufacturing of the antirotation device itself, but also of a retaining part of said element for the antirotation device and easy mounting.

This problem is solved by subject of claim 1. Beneficial embodiments are described in the dependent claims.

According to claim 1 an antirotation device for an element being moveable back and forth along an axis, particularly a periodically actuable tappet for a valve train or a pump comprises following features:
The device is substantially mushroom-shaped consisting of one trunk section and one head section,
the trunk section is circular-cylindrical-like and designed to be arranged in a circular hole or cavity of said element, particularly of a hollow circular-cylindrical part of said element, and
the head section is between a longitudinal cut-off of a circular-like cylinder and a cut-off of a spherical and designed to slide in a guide of a bore surrounding said element.

Through the generally mushroom-shaped configuration of the antirotation device, a radially insert excursion of the antirotation device in a hole of the element for the trunk section of the antirotation device is with advantage effectively prevented. Due to the shape of the antirotation device can be manufactured very cost effectively particularly by cold pressing. Also the hole in the element for said trunk section can be produced very cost-effectively due to the circular-cylindrical shape of the hole corresponding to the circular-cylindrical shape of the trunk section. The shape of the head section ensures a good guidance of said element e.g. a cam follower in said bore. Due to the shape of the head section the contact area between the antirotation device and said bore is wide and prevents wear in this contact. Moreover particularly if the front sides of the head section are bulged to the outside, these round ends ensure that the antirotation device will not generate scratches in said bore.

Further advantages, features and details of the invention are explained in the following examples of the invention with respect to the drawings.

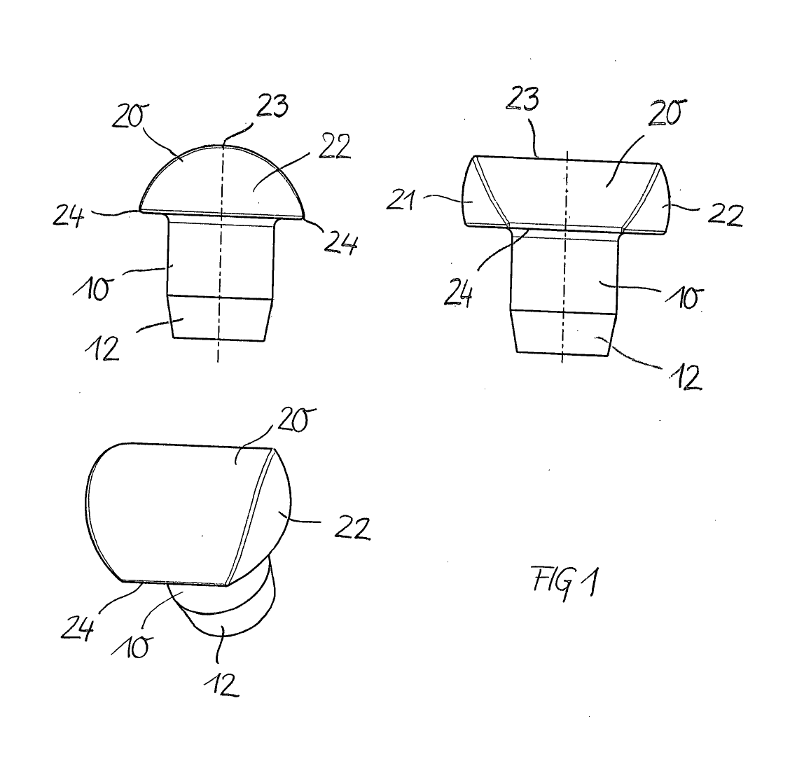

FIG. 1 shows an antirotation device according to a first embodiment of the invention, whereby in the left top a front view is shown, in the right top a side view and in the bottom a perspective view.

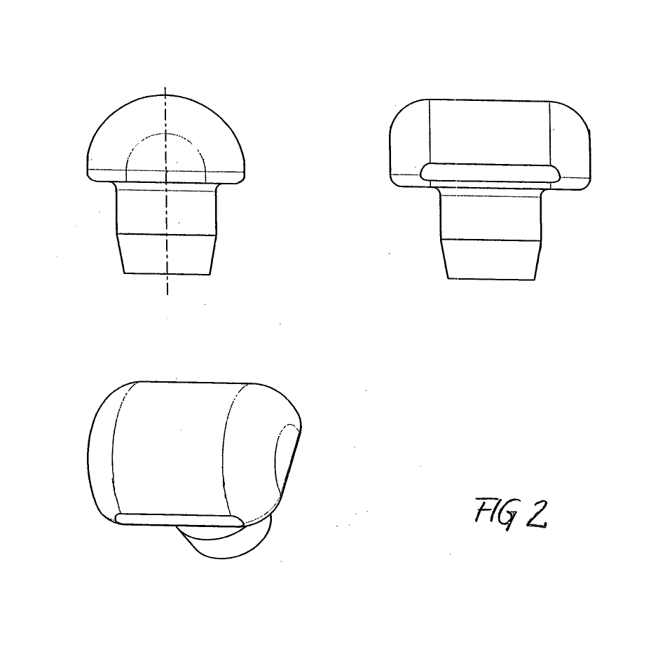

FIG. 2 shows an antirotation device according to a second embodiment of the invention, whereby in the left top a front view is shown, in the right top a side view and in the bottom a perspective view.

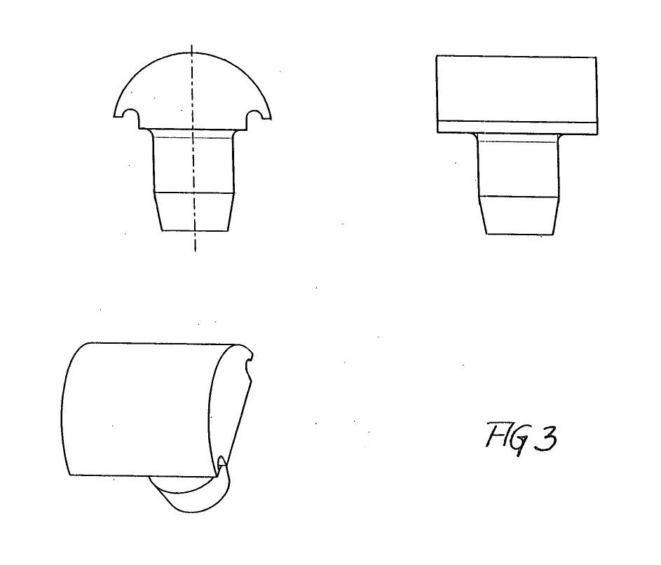

FIG. 3 shows a antirotation device according to a third embodiment of the invention, whereby in the left top a front view is shown, in the right top a side view and in the bottom a perspective view.

FIG. 1 shows as one example of the invention an antirotation device, which is substantially mushroom-shaped consisting of one trunk section 10 and one head section 20. The trunk section 10 is circular-cylindrical-like and designed to be arranged in a circular hole or cavity of an element being moveable back and forth along an axis, particularly a periodically actuable tappet for a valve train or a pump, particularly of a hollow circular-cylindrical part of said element. The trunk section 10 comprises a frustum-like section 12 at an axial end of the trunk section being away from the head section 20. This makes it easier to insert the trunk section 10 in said hole. Thereby the diameter of the circular cylindrical trunk section may be ca. 2.5 mm and its length ca. 2.9 mm. The angle of frustum-like section may be around 10°.

The head section 20 is like a longitudinal cut-off of a circular-like cylinder and designed to slide in a guide of a bore surrounding said element. Thereby the head section 20 is bulged to the outside at its front sides 21 and 22 generating rounded longitudinal end sections. This provides good sliding properties in said guide. Further the head section 20 has on top in a longitudinal direction a ridge line 23 and two longitudinal sidelines 24, bordering the cylindrical jacket of the head section 20, whereby the ridge line 23 is longer than the sidelines 24 and the front sides 21 and 22 of the head section 20 are rounded to merge from the ridge line 23 to the sidelines 24. The length of ridge line 23 may be ca. 3 mm, of the sidelines ca. 2.5 and the entire length of the head section ca. 4.9 mm. So a ratio being the length of the ridge line 23 divided by the length of the sideline 24 shall be greater than ca. 1.1 and less than ca. 2. Particularly the before mentioned design of the head section 20 ensures a good guidance of said element in said bore as already mentioned in the paragraph after the solution of the problem.

In another embodiment the head section can be flattened in an area of its longitudinal sidelines bordering the cylindrical jacket of the head section as it is shown in FIG. 2, whereby also the further shape of the head section of the antirotation device of FIG. 2 is a little bit different compared with the head section 20 of the anti-rotation device of FIG. 1. Thereby the front sides of the head section of the antirotation device of FIG. 2 are spherically rounded having a plane area in the center of the front sides.

In another embodiment the head section can comprise at its underside in a transition area from the cylindrical jacket of the head section to the trunk section at least one, particularly in a longitudinal direction of the head section extending groove being bulged to the inside of the head section as it is shown in FIG. 3, whereby also the further shape of the head section of the antirotation device of FIG. 3 is a little bit different compared with the head sections 20 of the antirotation devices of FIGS. 1 and 2. Thereby the head section of the antirotation device of FIG. 3 is a longitudinal half of a cylinder with plane front sides. In other embodiment the head section can also be more like a cut-off of a spherical having the advantage that such an anti-rotation device is axial symmetric with respect to its main axis, so that no predefined alignment between the antirotation device and said element has to be respected when mounting the trunk section of the antirotation device in said hole of said element.

In another embodiment the trunk section can comprises in a transition area from a circular-cylindrical section of the trunk section to the head section a cuboid-like section, whereby the axial length of said cuboid-like section is multiple shorter than of the circular-cylindrical section, whereby then also the hole for the trunk section in said element is formed accordingly.

The antirotation device is produced in a one-piece-design and is made of steel. The antirotation device is manufactured via a cold pressing and/or impact extruding operation which is followed by a hardening operation, particularly a carbonitrating operation.

1. An antirotation device for an element moveable reciprocatably along an axis and having a generally circular hole, the element being disposeable within a bore, the device comprising:
a substantially mushroom-shaped body including a trunk section and a head section, the trunk section is being generally circular-cylindrical and disposeable within the circular hole of the element, and the head section being configured to slide in a guide of the bore surrounding the element and generally shaped as a longitudinal cut-off of a circular cylinder.

2. The antirotation device according to claim 1, wherein the head section has opposing front sides and is at least one of bulged to the outside at each front side and generally spherically rounded to the outside at each front side.

3. The antirotation device according to claim 2, wherein the head section has a generally rectangular end section connected with the trunk section, a top, longitudinally-extending ridge line and two longitudinal sidelines bordering the rectangular end section, the ridge line being longer than the sidelines and the front sides of the head section being rounded to merge from the ridge line to the sidelines.

4. The antirotation device according to claim 3, wherein the head section is generally flattened in an area of the longitudinal sidelines bordering the head rectangular end section.

5. The antirotation device according to claim 3, wherein the head section has at least one longitudinally-extending groove formed in the rectangular end section and being bulged to the inside of the head section.

6. The antirotation device according to claim 1, wherein the trunk section has an axial end opposing the head section and includes a frustum-like section at the axial end.

7. The antirotation device according to claim 1, wherein the trunk section includes a substantially circular-cylindrical section and a cuboid-like section providing a transition area from the circular-cylindrical section to the head section, an axial length of the cuboid-like section being substantially lesser than an axial length of the circular-cylindrical section.

8. The antirotation device according to claim 1, wherein the device is produced in a one-piece-design.

9. The antirotation device according to claim 1, wherein the device is made of steel.

10. The antirotation device according to claim 1, wherein the device is cold-pressed.

11. The antirotation device according to claim 1, wherein the device is impact extruded.

12. The antirotation device according to claim 1, wherein the device is formed by one of cold-pressing and impact extrusion and then hardened.

13. The antirotation device according to claim 12, wherein the device is hardened by carbonitrating.

14. (canceled)

15. The antirotation device according to claim 1, wherein the trunk section of the antirotation device is retained in the circular hole of the element by one of pressing-in, gluing, welding, soldering and riveting.

16. The antirotation device as recited in claim 1, wherein the element is a periodically actuatable tappet of a valve.
